(19) United States
(12) Patent Application Publication
(10) Pub. No.: US 2014/0289504 A1
(43) Pub. Date: Sep. 25, 2014

(54) COMPUTER WITH STARTING UP KEYBOARD

(71) Applicants: HON HAI PRECISION INDUSTRY CO., LTD., New Taipei (TW); HONG FU JIN PRECISION INDUSTRY (WuHan) CO., LTD., Wuhan (CN)

(72) Inventor: ZHONG-GANG WU, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 14/065,646

(22) Filed: Oct. 29, 2013

(30) Foreign Application Priority Data
Mar. 20, 2013 (CN) 2013100896556

(51) Int. Cl. G06F 9/44

(52) U.S. Cl. CPC G06F 9/4401
USPC 713/2

(57) ABSTRACT

A computer includes a keyboard, a PCB, a south bridge chip, a BIOS chip, a buffer circuit, and a USB switch. The PCB includes a USB connector connected to the keyboard. The BIOS chip is connected to the south bridge. The USB switch includes a control pin and a first output pin. The BIOS chip sends a dormancy command to the keyboard via the south bridge chip after the computer receives a shut-down signal. The south bridge chip sends a first control signal to the control pin to enable the USB switch to turn on the first output pin after the computer is powered off. The keyboard sends a triggering signal to the USB switch. The first output pin sends the triggering signal to the south bridge chip via the buffer circuit to enable the computer to start up.

### BACKGROUND

1. Technical Field

The present disclosure generally relates to a computer with a keyboard.

2. Description of Related Art

Computers include a host and a display. The host is triggered to start up when a power button of the host is pressed. However, the host may be placed in a position where a person can not reach the power button conveniently. Therefore, a more convenient operation to start up the computer is needed.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a schematic view of one embodiment of a computer.

FIG. 2 is a block diagram of components of the computer of FIG. 1.

FIG. 3 is a circuit diagram of one embodiment of a phase detecting system.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

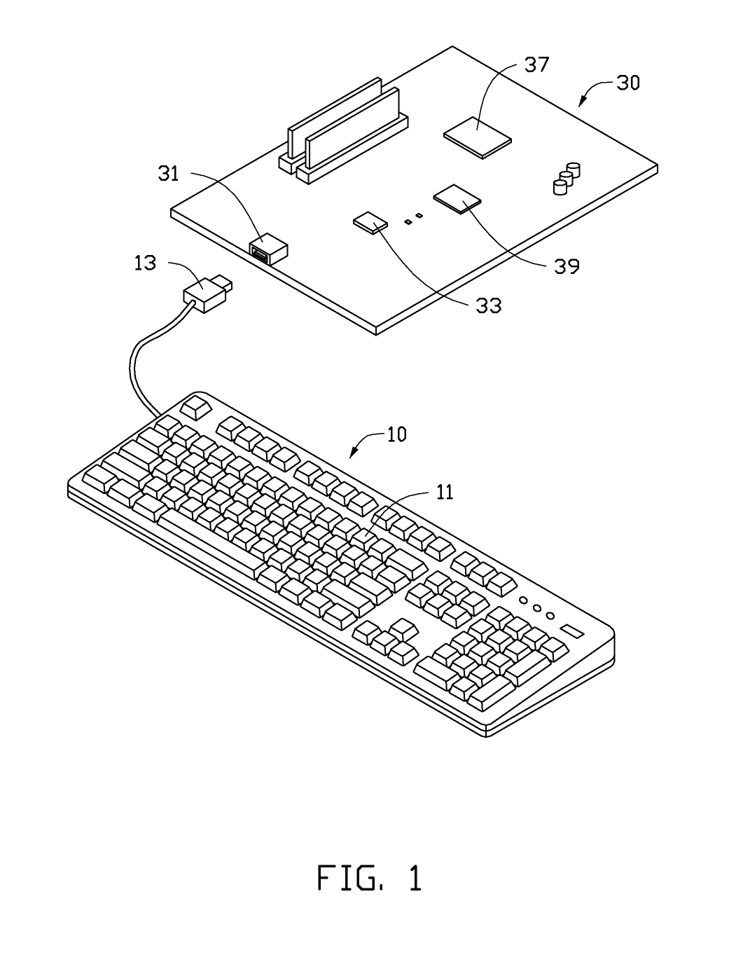

FIG. 1 shows a schematic view of a computer according to one embodiment. The computer includes a keyboard 10 and a printed circuit board (PCB) 30 connected to the keyboard 10.

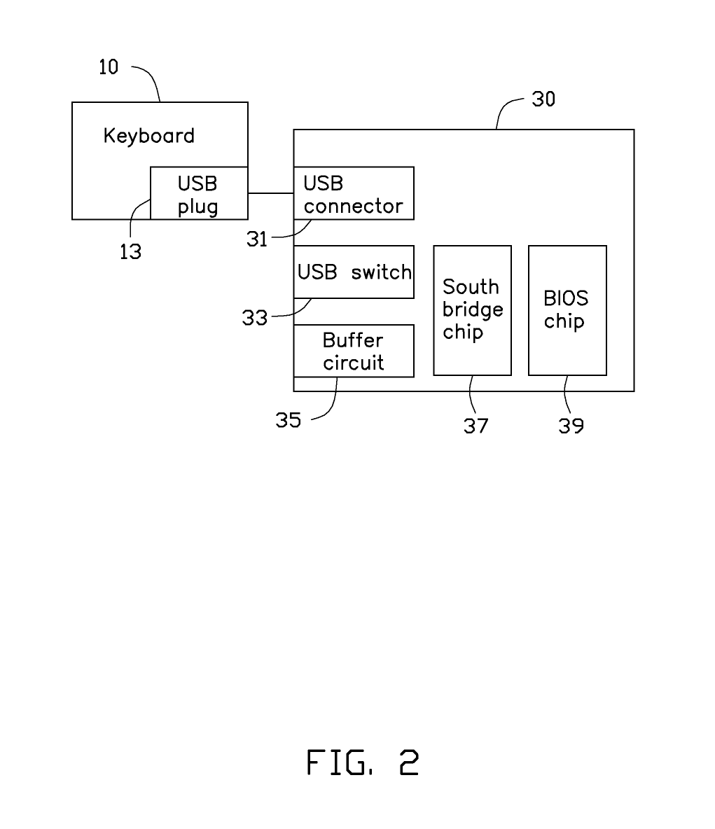

FIG. 2 shows that the keyboard 10 includes a board body 11 and a USB plug 13 connected to the board body 11. The board body 11 includes a plurality of keys. The printed circuit board 30 includes a USB connector 31 for connecting to the USB plug 13, a USB switch 33 connected to the USB connector 31, a buffer circuit 35, a south bridge chip 37 connected to the buffer circuit 35, and a BIOS chip 39 connected to the south bridge chip 37.

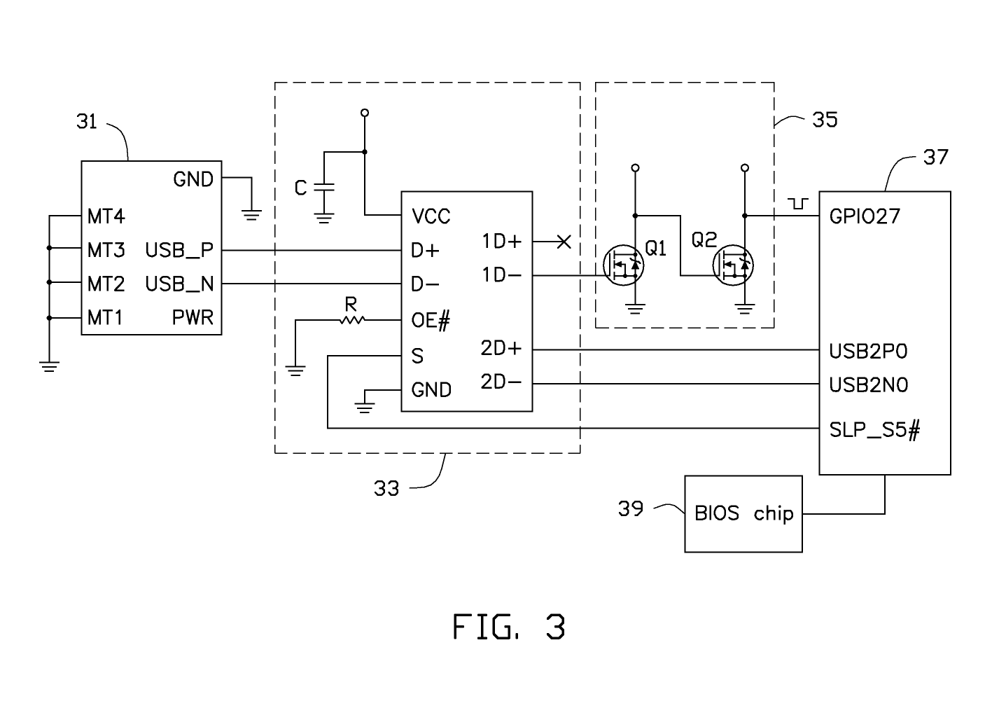

FIG. 3 shows that the USB connector 31 includes a pair of differential signal pins USB_P and USB_N connected to two input pins D+ and D−, respectively, of the USB switch 33. The USB switch 33 includes a control pin S, two first output pins 1D+, 1D−, two second output pins 2D+, 2D−, a power pin VCC, and a ground pin GND. The power pin VCC is connected to a power source. The power pin VCC is ground via a capacitor C. The control pin S of the USB switch 33 is connected to an output end SLP_S5# of the south bridge chip 37. After the computer receives a start-up signal from pressing a power button (not shown), the output end SLP_S5# outputs a high-level control signal to the control pin S to enable the second output pins 2D+, 2D− to be connected to the input pins D+, D−, respectively. After the computer receives a shut-down signal from pressing the power button, the output end SLP_S5# outputs a low-level control signal to the control pin S to enable the first output pins 1D+, 1D− to be connected to the input pins D+, D−, respectively. The second output pins 2D+ and 2D− are further connected to two data pins USB2P0 and USB2N0, respectively, of the south bridge chip 37.

The buffer circuit 35 includes a first switch element Q1 and a second switch element Q2. In one embodiment, the first switch element Q1 and the second switch element Q2 are both field-effect transistors. A gate of the first switch element Q1 is connected to the output pin 1D−. A drain of the first switch element Q1 is connected to a power source (not shown) and is connected to the gate of the second switch element Q2. A source of the first switch element Q1 is ground. A drain of the second switch element Q2 is connected to a power source (not shown) and is further connected to a start-up end GPIO27 of the south bridge chip 37. The source of the second switch element Q2 is ground.

When the computer receives a shut-down signal from pressing the power button, the BIOS chip 39 sends a dormancy command to the south bridge chip 37. The south bridge chip 37 sends the dormancy command to the keyboard 10 via the data pins USB2P0, USB2NO to enable the keyboard 10 to be in a dormant state. After the computer receives the shut-down signal, the output end SLP_S5# of the south bridge chip 37 sends a low-level control signal to the control pin S to enable the first output pins 1D+, 1D− to be connected to the input pins D+, D−. A key of the keyboard 10 is pressed to produce a triggering signal. The triggering signal is sent to the output pin 1D− via the differential signal pin USB_N. The triggering signal is sent from the output pin 1D− to the first switch Q1 of the buffer circuit 35. The triggering signal is then sent from the buffer circuit 35 to the start-up pin GPIO27 to enable the computer to start up.

It is to be understood, however, that even though numerous characteristics and advantages of the embodiments have been set forth in the foregoing description, together with details of the structure and function of the embodiments, the disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. A computer comprising:
a keyboard, the keyboard comprises a USB plug;
a printed circuit board, the printed circuit board comprises a USB connector connected to the USB plug;
a south bridge chip;
a BIOS chip, the BIOS chip connected to the south bridge chip;
a buffer circuit; and
a USB switch, the USB switch comprises a control pin and a first output pin, the first output pin is connected to the buffer circuit; and the control pin is connected to the south bridge chip;
wherein the buffer circuit is connected between the USB switch and the south bridge chip; the BIOS chip is configured to send a dormancy command to the keyboard to enable the keyboard to be a dormant state via the south bridge chip after the computer receives a start-up signal; the south bridge chip is configured to send a first control signal to the control pin to enable the USB switch to turn on the first output pin after the computer is powered off because of a shut-down signal; the keyboard is configured to send a triggering signal to the USB switch after a key of keyboard is pressed and the computer is powered off; and the first output pin of the USB switch is configured to send the triggering signal to the south bridge chip via the buffer circuit to enable the computer to start up.

2. The computer of claim 1, wherein the buffer circuit comprises a first field effect transistor and a second field effect transistor; the first field effect transistor and the second field effect transistor are turned on when receiving a high level signal; the first field effect transistor comprises a first field effect transistor gate, a first field effect transistor drain, and a first field effect transistor source; the second field effect transistor comprises a second field effect transistor gate, a second field effect transistor drain, and a second field effect transistor source; the first field effect transistor gate is connected to the first output pin; the first field effect transistor drain is connected to a power source; the first field effect transistor source is grounded; the second field effect transistor gate is connected to the first field effect transistor drain; the second field effect transistor drain is connected to a power source; the second field effect transistor source is grounded; the second field effect transistor drain is connected to the south bridge chip.

3. The computer of claim 1, wherein the USB switch comprises a pair of differential signal pins and two second output pins connected to the south bridge chip; the south bridge chip is configured to send a second control signal to the control pin to enable the USB switch to turn on the two second output pins, thereby receiving the triggering signal.

4. The computer of claim 3, wherein the second control signal is high level.

5. The computer of claim 1, wherein the USB switch comprises a power pin, the power pin is connected to a second power source, and the second power source is grounded via a capacitor.

6. The computer of claim 1, wherein the first control signal is low level.
